(19) United States
(12) Patent Application Publication
(10) Pub. No.: US 2026/0234333 A1
(43) Pub. Date: Aug. 13, 2026

(54) POLYAMIDE-IMIDE, RESIN COMPOSITION, MOLDED ARTICLE, AND FILM

(71) Applicant: KANEKA CORPORATION, Osaka (JP)

(72) Inventors: Fumiyasu Ishiguro, Osaka (JP); Keisuke Katayama, Osaka (JP); Yuki Kawashima, Osaka (JP)

(73) Assignee: KANEKA CORPORATION, Osaka (JP)

(21) Appl. No.: 19/638,399

(22) Filed: Apr. 3, 2026

Related U.S. Application Data
(63) Continuation of application No. PCT/JP2024/033443, filed on Sep. 19, 2024.

(30) Foreign Application Priority Data
Oct. 3, 2023 (JP) 2023-171898
Oct. 3, 2023 (JP) 2023-171902

(51) Int. Cl. C08G 73/14; C08J 5/18; C08L 33/04; C08L 79/08

(52) U.S. Cl. CPC C08G 73/14; C08J 5/18; C08L 33/04; C08L 79/08; C08J 2333/04; C08J 2379/08; C08L 2203/16

(57) ABSTRACT

A polyamide-imide and a resin composition contain a polyamide-imide and an acryl-based resin. The polyamide-imide contains a diamine component, a tetracarboxylic dianhydride component and a polycarboxylic acid component. The diamine component includes a diamine having one or more structures selected from CF₃—O—, —(CF₂—O)ₙ—, and —O—(CF₂—CF₂—O)ₙ—, where n is an integer of 1-20. The diamine may be 2,2′-bis(trifluoromethoxy)benzidine, 3,3′-bis(trifluoromethoxy)benzidine, 2,3′-bis(trifluoromethoxy)benzidine, or the like.

### TECHNICAL FIELD

One or more embodiments of the present invention relate to a polyamide-imide, a resin composition containing the polyamide-imide, and a molded article such as a film.

### BACKGROUND

Electronics devices such as display devices such as liquid crystal displays, organic EL displays and electronic papers, solar cells, and touch panels are required to be thin, lightweight and flexible. Glass materials that are used for these devices are replaced by film materials to make the devices flexible, thin and lightweight. As a replacement for glass, a transparent polyimide film has been developed and used for substrates for displays, cover films and the like. Patent Document 1 proposes using a polyamide-imide film as a material of a cover film of flexible displays.

As a method for producing a polyamide-imide film having high transparency, a method using an organic solvent-soluble polyamide-imide resin, which does not require high-temperature imidization after being formed into a film, has been proposed. For such a soluble polyamide-imide, a fluorine-containing compound is used as a monomer, i.e., as a diamine and/or as a tetracarboxylic dianhydride, from the viewpoint of balancing transparency and mechanical properties. For example, in a polyamide-imide of Patent Document 1, 2,2′-bis(trifluoromethyl)benzidine (TFMB) is used as the diamine and 4,4′-(hexafluoroisopropylidene)diphthalic anhydride (6FDA) is used as the tetracarboxylic dianhydride.

Patent Document 2 describes that the transparency and the like of a film can be improved by mixing a soluble polyamide-imide and an acryl-based resin.

### PATENT DOCUMENTS

Patent Document 1: International Publication No. WO 2013/048126
Patent Document 2: International Publication No. WO 2023/132310

### SUMMARY

In recent years, the environmental persistence of an organic fluorine compound (PFAS) has become a growing concern. In general, a carbon-fluorine bond contained in the organic fluorine compound has high bond energy and is resistant to decomposition in the environment. In particular, an organic fluorine compound containing a structure in which a trifluoromethyl group is bonded to a carbon atom (—C—CF₃) or a structure in which a carbon atom is bonded to each of both ends of a difluoromethylene group (—C—CF₂—C—) has low degradability in the environment, and it is also pointed out that the organic fluorine compound has adverse effects on human health.

In view of the above, a polyamide-imide which is excellent in environmental safety, soluble in an organic solvent, and having excellent transparency, a resin composition containing the polyamide-imide, and a molded article such as a film are provided.

One or more embodiments of the present invention relate to a polyamide-imide and a resin composition containing the polyamide-imide and an acryl-based resin. The polyamide-imide contains a fluorine atom-containing diamine (specific diamine) having one or more structures selected from CF₃—O—, —(CF₂—O)ₙ—, and —O—(CF₂—CF₂—O)ₙ— as a diamine component. n in —(CF₂—O)ₙ— and —O—(CF₂—CF₂—O)ₙ— is an integer of 1 to 20.

Preferred examples of the specific diamine which is the fluorine atom-containing diamine include 2,2′-bis(trifluoromethoxy)benzidine, 3,3′-bis(trifluoromethoxy)benzidine, and 2,3′-bis(trifluoromethoxy)benzidine.

The polyamide-imide may contain, as a tetracarboxylic dianhydride component, one or more tetracarboxylic dianhydrides (specific acid dianhydrides) selected from the group consisting of a tetracarboxylic dianhydride having an ether bond, a tetracarboxylic dianhydride having a fluorene structure, a tetracarboxylic dianhydride having a xanthene structure, and a bis(trimellitic anhydride) ester.

Examples of the specific acid dianhydride include 4,4′-(4,4′-isopropylidenediphenoxy)diphthalic anhydride, 3,4′-oxydiphthalic anhydride, 4,4′-oxydiphthalic anhydride, 9,9-bis(3,4-dicarboxyphenyl)fluorene dianhydride, 9,9-bis[4-(3,4-dicarboxyphenoxy)phenyl]fluorene dianhydride, 5,5′-[9H-fluorene-9-ylidenebis(2-methyl-4,1-phenylene)]bis(1,3-dihydro-1,3-dioxo-5-isobenzofurancarboxylate), spiro[fluorene-9,9′-xanthene]-2′,3′,6′,7′-tetracarboxylic dianhydride, 5,5′-spiro[9H-fluorene-9,9′-[9H]xanthene]-3′,6′-diylbis(1,3-dihydro-1,3-dioxo-5-isobenzofurancarboxylate), p-phenylene bis(trimellitic acid monoester acid anhydride), bis(1,3-dioxo-1,3-dihydroisobenzofuran-5-carboxylic acid)-biphenyl-4,4′-diyl, and bis(1,3-dioxo-1,3-dihydroisobenzofuran-5-carboxylic acid)-2,2′,3,3′,5,5′-hexamethylbiphenyl-4,4′-diyl.

The polyamide-imide may contain a diamine other than the specific diamine as the diamine component, and may contain a tetracarboxylic dianhydride other than the specific acid dianhydride as the tetracarboxylic dianhydride component.

Examples of the tetracarboxylic dianhydride other than the specific acid dianhydride include 2,3,3′,4′-biphenyltetracarboxylic dianhydride, 3,3′,4,4′-biphenyltetracarboxylic dianhydride, 2,2′,3,3′-biphenyltetracarboxylic dianhydride, pyromellitic dianhydride, 1,2,3,4-benzenetetracarboxylic dianhydride, and 3,3′,4,4′-diphenylsulfonetracarboxylic dianhydride.

The tetracarboxylic dianhydride other than the specific acid dianhydride may be an alicyclic tetracarboxylic dianhydride. Examples of the alicyclic tetracarboxylic dianhydride include 1,2,3,4-cyclobutanetetracarboxylic dianhydride, 1,2,3,4-cyclopentanetetracarboxylic dianhydride, 1,2,4,5-cyclohexanetetracarboxylic dianhydride, 4-(2,5-dioxotetrahydrofuran-3-yl)-1,2,3,4-tetrahydronaphthalene-1,2-dicarboxylic anhydride, bicyclo[2.2.2]octa-7-ene-2,3,5,6-tetracarboxylic dianhydride, bicyclo[2.2.2]octane-2,3,5,6-tetracarboxylic dianhydride, and 1,1′-bicyclohexane-3,3′,4,4′tetracarboxylic acid-3,4:3′,4′-dianhydride. The amount of the alicyclic tetracarboxylic dianhydride with respect to the total amount of the tetracarboxylic dianhydride component of the polyamide-imide may be 1 to 80 mol %.

In the polyamide-imide, the amount of a diamine having a structure in which CF₃— or —C(CF₃)₂— is directly bonded to a carbon atom of an aromatic ring may be less than 0.5 mol % with respect to the total amount of the diamine component, and the amount of a tetracarboxylic dianhydride having a structure in which CF₃— or —C(CF₃)₂— is directly bonded to a carbon atom of an aromatic ring may be less than 0.5 mol % with respect to the total amount of the tetracarboxylic dianhydride component.

The polyamide-imide may be soluble in dimethylformamide at 23° C.

The resin composition of one or more embodiments of the present invention contains the polyamide and the acryl-based resin. The resin composition may contain the polyamide-imide and an acryl-based resin at a weight ratio of 98:2 to 2:98.

The polyamide-imide and the resin composition can be applied to a molded article such as a film.

A polyamide-imide of one or more embodiments of the present invention containing a specific diamine as a diamine component is excellent in solubility in an organic solvent and transparency. Since the specific diamine has lower environmental persistence than that of an organic fluorine compound such as fluoroalkyl-substituted benzidine, the polyamide-imide of one or more embodiments of the present invention is excellent in environmental safety.

### DETAILED DESCRIPTION

### [Polyamide-Imide]

The polyamide-imide is a polymer having an imide structural unit represented by general formula (I) and an amide structural unit represented by general formula (II) and/or an amide-imide structural unit represented by general formula (III).

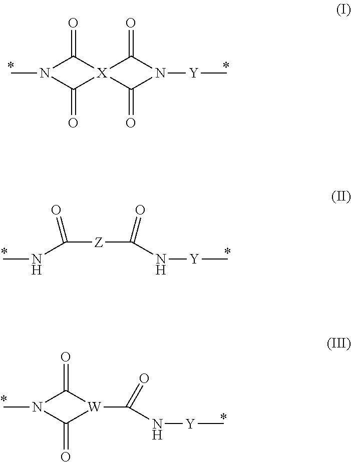

In general formulas (I) to (III), X is a tetravalent organic group, Y and Z are divalent organic groups, and W is a trivalent organic group. Y is a diamine residue, and is an organic group obtained by removing two amino groups from a diamine represented by the following general formula (V). X is a tetracarboxylic dianhydride (hereinafter, may be referred to as “acid dianhydride”) residue, and is an organic group obtained by removing two carboxy anhydride groups from a tetracarboxylic dianhydride represented by the following general formula (IV). Z is a dicarboxylic acid residue, and is an organic group obtained by removing two carboxy groups from a dicarboxylic acid represented by the following general formula (VI). W is a tricarboxylic anhydride residue, and is an organic group obtained by removing a carboxy anhydride group and a carboxy group from a tricarboxylic anhydride represented by the following general formula (VII).

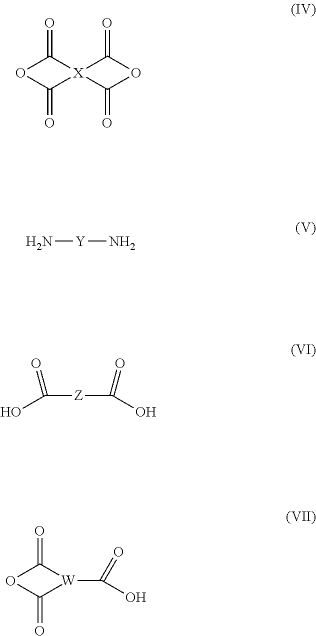

In other words, the polyamide-imide includes a diamine-derived structure represented by the following general formula (Va) and a tetracarboxylic dianhydride-derived structure represented by the following general formula (IVa), and further includes one or more structures selected from the group consisting of a dicarboxylic acid-derived structure represented by the following general formula (VIa) and a tricarboxylic anhydride-derived structure represented by the following general formula (VIIa). The diamine-derived structure (Va) and the tetracarboxylic dianhydride-derived structure (IVa) form an imide bond to constitute the imide structural unit represented by general formula (I), the diamine-derived structure (Va) and the dicarboxylic acid-derived structure (VIa) form an amide bond to constitute the amide structural unit represented by general formula (II), and the carboxy anhydride group portion and the carboxy group portion of the tricarboxylic anhydride-derived structure (VIIa) form an imide bond and an amide bond at the respective sites of the diamine-derived structure (Va), respectively, to constitute the amide-imide structural unit represented by general formula (III).

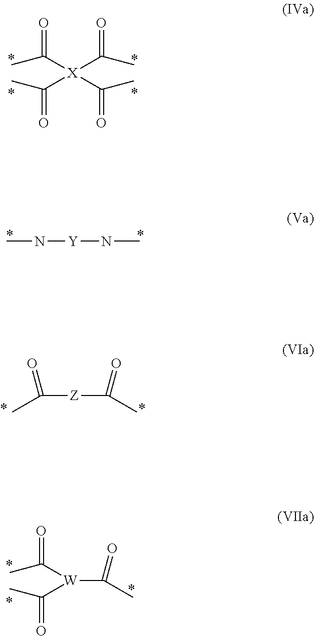

The polyamide-imide may contain two or more types of diamine residues Y, two or more types of tetracarboxylic dianhydride residues X, two or more types of dicarboxylic acid residues Z, or two or more types of tricarboxylic anhydride residues W.

As described in detail later, the polyamide-imide is generally obtained by synthesizing a polyamic acid using, as monomers, a diamine, a tetracarboxylic dianhydride, and a polycarboxylic acid derivative such as a dicarboxylic acid dichloride or a tricarboxylic acid anhydride chloride, and subjecting an amic acid as a site where the tetracarboxylic acid or the tricarboxylic acid and the diamine are linked together to dehydration cyclization. As a monomer as a starting material, a polycarboxylic acid derivative such as a dicarboxylic acid dichloride or a tricarboxylic acid anhydride chloride is used, but the resulting polyamide-imide has a structure Z (dicarboxylic acid residue) obtained by removing two carboxy groups from a dicarboxylic acid or a structure W obtained by removing three carboxy groups from a tricarboxylic acid. Regardless of the types of starting materials (monomers) used for synthesizing the polyamide-imide, a structure corresponding to the tetracarboxylic dianhydride residue X contained in the polyamide-imide is expressed as a “tetracarboxylic dianhydride component”, a structure corresponding to the diamine residue Y is expressed as a “diamine component”, and a structure corresponding to the dicarboxylic acid residue Z and a structure corresponding to the tricarboxylic anhydride residue W are expressed as a “polycarboxylic acid component”.

Hereinafter, the diamine component, the tetracarboxylic dianhydride component, and the polycarboxylic acid component as monomer units constituting the polyamide-imide will be described with reference to examples.

### <Diamine>

### (Specific Diamine)

The polyamide-imide of one or more embodiments of the present invention contains a diamine having one or more structures selected from CF₃—O—, —(CF₂—O)ₙ—, and —O—(CF₂—CF₂—O)ₙ—, as a diamine component. n is an integer of 1 to 20. Hereinafter, these diamines are referred to as a “specific diamine”.

In the specific diamine, a carbon atom of a trifluoromethyl group (—CF₃) or a carbon atom of a difluoromethylene group (—CF₂—) is bonded to an oxygen atom, and the specific diamine tends to have higher degradability and lower environmental persistence than those of a structure in which a trifluoromethyl group is bonded to a carbon atom (—C—CF₃) or a structure in which a carbon atom is bonded to each of both ends of a difluoromethylene group (—C—CF₂—C—). Therefore, the polyamide-imide containing the specific diamine as the diamine component is more excellent in environmental safety than that of a conventional soluble polyamide-imide containing an organic fluorine compound such as fluoroalkyl-substituted benzidine as the diamine component.

Among the specific diamines, those having CF₃—O— or —(CF₂—O)ₙ— are preferable because they do not correspond to a “specific fluorine structure” described later, and from the viewpoint of the polymerizability and mechanical strength of the polyamide-imide, diamines having a trifluoromethoxy group (CF₃—O—) are preferable. In particular, diamines in which an oxygen atom of the trifluoromethoxy group is bonded to a carbon atom of an aromatic ring are preferable. From the viewpoint of reactivity, the diamines in which the trifluoromethoxy group is bonded to the carbon atom of the aromatic ring may have no fluorine atom directly bonded to the aromatic ring to which the trifluoromethoxy group is bonded, and may have no fluorine atom other than the trifluoromethoxy group. Examples of the specific diamine in which the trifluoromethoxy group is bonded to the carbon atom of the aromatic ring include trifluoromethoxy-substituted benzidine and trifluoromethoxy-substituted phenylenediamine.

Examples of the trifluoromethoxy-substituted benzidine include 2-(trifluoromethoxy)benzidine, 3-(trifluoromethoxy)benzidine, 2,3-bis(trifluoromethoxy)benzidine, 2,5-bis(trifluoromethoxy)benzidine, 2,6-bis(trifluoromethoxy)benzidine, 2,3,5-tris(trifluoromethoxy)benzidine, 2,3,6-tris(trifluoromethoxy)benzidine, 2,3,5,6-tetrakis(trifluoromethoxy)benzidine, 2,2′-bis(trifluoromethoxy)benzidine (TFMOB), 3,3′-bis(trifluoromethoxy)benzidine, 2,3′-bis(trifluoromethoxy)benzidine, 2,2′,3-tris(trifluoromethoxy)benzidine, 2,3,3′-tris(trifluoromethoxy)benzidine, 2,2′,5-tris(trifluoromethoxy)benzidine, 2,2′,6-tris(trifluoromethoxy)benzidine, 2,3′,5-tris(trifluoromethoxy)benzidine, 2,3′,6-tris(trifluoromethoxy)benzidine, 2,2′,3,3′-tetrakis(trifluoromethoxy)benzidine, 2,2′,5,5′-tetrakis(trifluoromethoxy)benzidine, and 2,2′,6,6′-tetrakis(trifluoromethoxy)benzidine.

Examples of the trifluoromethoxy-substituted phenylenediamine include 1,2-diamino-4-(trifluoromethoxy)benzene, 1,3-diamino-4-(trifluoromethoxy)benzene, 1,4-diamino-2-(trifluoromethoxy)benzene, 1,4-diamino-2,3-bis-(trifluoromethoxy)benzene, 1,4-diamino-2,5-bis(trifluoromethoxy)benzene, 1,4-diamino-2,6-bis(trifluoromethoxy)benzene, 1,4-diamino-2,3,5-tris(trifluoromethoxy)benzene, and 1,4-diamino-2,3,5,6-tetrakis(trifluoromethoxy)benzene.

From the viewpoint of the polymerizability and mechanical strength of the polyamide-imide, the specific diamine may be the trifluoromethoxy-substituted benzidine. In particular, those having a trifluoromethoxy group at the 2- or 3-position of biphenyl are preferable. Among them, 2,2′-bis(trifluoromethoxy)benzidine (hereinafter, referred to as “TFMOB”), 3,3′-bis(trifluoromethoxy)benzidine, and 2,3′-bis(trifluoromethoxy)benzidine are more preferable, and TFMOB is particularly preferable, from the viewpoint of the solubility of the polyamide-imide resin in an organic solvent, and compatibility with other resins, and the like. By having the trifluoromethoxy group at the 2- or 3-position of biphenyl, li-li stacking between benzene rings is inhibited due to the steric hindrance of the trifluoromethoxy group in addition to a decrease in π electron density due to the electron withdrawing property of the trifluoromethoxy group, so that an absorption edge wavelength shifts to the short wavelength side, and the coloring of the polyamide-imide can be reduced. In TFMOB, due to the steric hindrance between the trifluoromethoxy groups at the 2-position and the 2′-position of biphenyl, a bond between two benzene rings of biphenyl is twisted, and the planarity of r conjugation is reduced, so that the absorption edge wavelength shifts to the short wavelength side, and the coloring of the polyamide-imide can be reduced.

The amount of the specific diamine with respect to the total amount of the diamine component may be 10 mol % or more, 30 mol % or more, 50 mol % or more, 60 mol % or more, 70 mol % or more, 80 mol % or more, or 90 mol % or more, or 100 mol %. In particular, the amount of the trifluoromethoxy group-containing diamine may be within the above range, and the amount of the trifluoromethoxy-substituted benzidine may be within the above range. As the ratio of the specific diamine is higher, coloring is suppressed, and mechanical strengths such as pencil hardness, elastic modulus, breaking strength, and breaking elongation of the film may be improved.

(Diamine Other than Specific Diamine)

The polyamide-imide may contain a diamine other than the specific diamine as the diamine component. From the viewpoint of the environmental safety of the polyamide-imide, one that does not contain —C—CF₃ and —C—CF₂—C— is preferable, and one that does not contain a fluorine atom is particularly preferable.

Examples of the diamine not containing a fluorine atom include 2,2′-dimethylbenzidine, p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 9,9-bis(4-aminophenyl)fluorene, 9,9-bis[4-(4-aminophenoxy)phenyl]fluorene, 9,9-bis(4-amino-3-methylphenyl)fluorene, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, trans-1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, isophoronediamine, 2,6-bis(aminomethyl)bicyclo[2.2.1]heptane, and 2,5-bis(aminomethyl)bicyclo[2.2.1]heptane.

By using diaminodiphenylsulfone as the diamine in addition to the specific diamine, the solvent-solubility and transparency of the polyamide-imide resin may be improved. Among the diaminodiphenylsulfones, 3,3′-diaminodiphenylsulfone (3,3′-DDS) and 4,4′-diaminodiphenylsulfone (4,4′-DDS) are preferable, and these may be used in combination.

When the diaminodiphenylsulfone is used in addition to the specific diamine, the amount of the diaminodiphenylsulfone with respect to the total amount of the diamine component may be 1 to 80 mol %, 3 to 60 mol %, or 5 to 30 mol %.

By using a diamine having a fluorene structure as the diamine in addition to the specific diamine, the solvent-solubility, transparency, and mechanical strength of the polyamide-imide resin may be improved. As the diamine containing fluorene structure, 9,9-bis(4-aminophenyl)fluorene, 9,9-bis[4-(4-aminophenoxy)phenyl]fluorene, and 9,9-bis(4-amino-3-methylphenyl)fluorene are preferable, and these may be used in combination.

When the diamine having a fluorene structure is used in addition to the specific diamine, the amount of the diamine having a fluorene structure with respect to the total amount of the diamine component may be 1 to 80 mol %, 3 to 60 mol %, or 5 to 30 mol %.

By using an alicyclic diamine as the diamine in addition to the specific diamine, the transparency of the polyamide-imide may be improved. Among the alicyclic diamines, isophoronediamine and 1,4-diaminocyclohexane are preferable, and these may be used in combination.

When the alicyclic diamine is used in addition to the specific diamine, the amount of the alicyclic diamine with respect to the total amount of the diamine component may be 1 to 70 mol %, 3 to 50 mol %, 5 to 40 mol %, 10 to 30 mol %, or 12 to 25 mol %.

The total amount of the specific diamine, the diaminodiphenylsulfone, the diamine having a fluorene structure, and the alicyclic diamine with respect to the total amount of the diamine component of the polyamide-imide may be 70 mol % or more, 80 mol % or more, 90 mol % or more, 95 mol % or more, 99 mol % or more, or 100 mol %.

Although the polyamide-imide may contain a fluorine atom-containing diamine other than the specific diamine as the diamine component, from the viewpoint of the environmental safety of the polyamide-imide, the amount of the fluorine atom-containing diamine other than the specific diamine with respect to the total amount of the diamine component of the polyamide-imide may be 30 mol % or less, 20 mol % or less, 10 mol % or less, 5 mol % or less, 1 mol % or less, or 0.5 mol % or less. The polyamide-imide may not contain the fluorine atom-containing diamine other than the specific diamine as the diamine component.

Among the fluorine atom-containing diamines, those having a structure in which a trifluoromethyl group is bonded to a carbon atom (—C—CF₃) and/or a structure in which a carbon atom is bonded to each of both ends of a difluoromethylene group (—C—CF₂—C—) have low degradability and raise concerns regarding environmental safety. A general soluble polyamide-imide contains, as the diamine component, a diamine having a structure in which CF₃— or —C(CF₃)₂— is directly bonded to a carbon atom of an aromatic ring (for example, trifluoromethyl-substituted benzidine such as 2,2′-bis(trifluoromethyl)benzidine, 2,2-bis[4-(4-aminophenoxy)phenyl]hexafluoropropane, 2,2-bis(3-amino-4-hydroxyphenyl)hexafluoropropane), from the viewpoint of enhancing the transparency and solvent-solubility of the polyamide-imide. However, from the viewpoint of the environmental safety of the polyamide-imide, it is preferable that these diamines are not substantially contained. The amount of the diamine in which CF₃— or —C(CF₃)₂— is directly bonded to a carbon atom of an aromatic ring with respect to the total amount of the diamine component of the polyamide-imide may be less than 0.5 mol %, or 0.3 mol % or less, 0.1 mol % or less, or 0.05 mol % or less, or may be 0.

### <Tetracarboxylic Dianhydride>

### (Specific Acid Dianhydride)

The acid dianhydride component in the polyamide-imide of one or more embodiments of the present invention is not particularly limited. From the view points of securing environmental safety and imparting solubility in an organic solvent, the polyamide-imide may contain, as the acid dianhydride component, one or more acid dianhydrides selected from the group consisting of an acid dianhydride having an ether bond, a bis(trimellitic anhydride) ester, an acid dianhydride having a fluorene structure, and an acid dianhydride having a xanthene structure. Hereinafter, these acid dianhydrides are referred to as a “specific acid dianhydride”.

Examples of the acid dianhydride having an ether bond include those in which two phthalic anhydrides are bonded via an ether bond (—O—) or a functional group containing an ether bond. Examples of the acid dianhydride in which two phthalic anhydrides are bonded via an ether bond include 3,4′-oxydiphthalic anhydride (a-ODPA) and 4,4′-oxydiphthalic anhydride (s-ODPA).

Examples of the functional group containing an ether bond include a bisphenol derivative structure. Examples of the acid dianhydride in which two phthalic anhydrides are bonded via a bisphenol derivative structure include a compound of the following general formula (5).

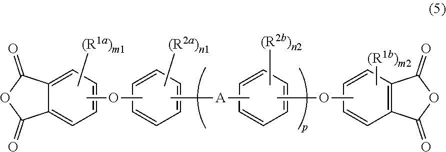

In general formula (5), Ais any divalent organic group, and p is 1 or 2. R^{1a}, R^{1b}, R^{2a}, and R^{2b} are each independently any substituent, m1 and m2 are each independently an integer of 0 to 3, and n1 and n2 are each independently an integer of 0 to 4.

Examples of the divalent organic group A include the following (a), (b), and (c). R^{3a} and R^{3b} in (a) are each independently a hydrogen atom, an alkyl group having 1 to 10 carbon atoms, or a phenyl group. R⁴ in (b) is an alkyl group having 1 to 10 carbon atoms, and k is an integer of 0 to 10. When k is 2 or more, a plurality of R⁴s may be the same or different.

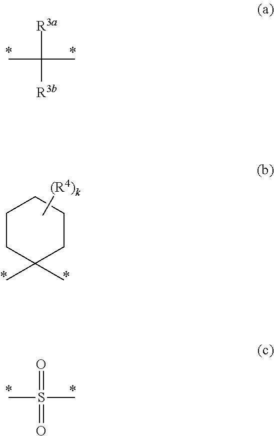

Examples of the substituents R^{1a} and R^{1b} and the substituents R^{2a} and R^{2b} include an alkyl group having 1 to 10 carbon atoms, an alkoxy group having 1 to 10 carbon atoms, a phenyl group, and a halogen.

From the viewpoint of the solubility of the polyamide-imide resin, as the acid dianhydride having an ether bond, those represented by general formula (1) are preferable, and in particular, 4,4′-(4,4′-isopropylidenediphenoxy)diphthalic anhydride (BPADA) is particularly preferable.

The bis(trimellitic anhydride) ester is represented by the following general formula (1).

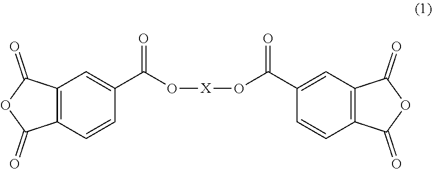

X in general formula (1) is an arbitrary divalent organic group, and a carboxy group and a carbon atom of X are bonded to each other at both ends of X. The carbon atom bonded to the carboxy group may form a ring structure. Specific examples of the divalent organic group X include the following (A) to (K).

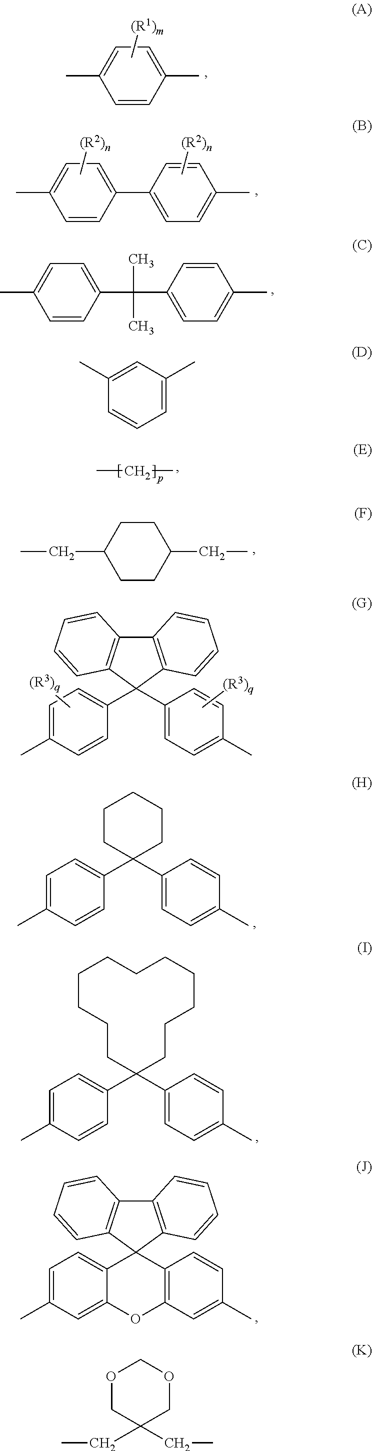

R¹ in formula (A) is an alkyl group having 1 to 20 carbon atoms or a fluorine atom, and m is an integer of 0 to 4. The group of formula (A) is one obtained by removing two hydroxyl groups from hydroquinone optionally having a substituent on a benzene ring. Examples of the hydroquinone derivative having a substituent on a benzene ring include tert-butylhydroquinone, 2,5-di-tert-butylhydroquinone and 2,5-di-tert-amylhydroquinone.

R² in formula (B) is an alkyl group having 1 to 20 carbon atoms or a fluorine atom, and n is an integer of 0 to 4. The group of formula (B) is one obtained by removing two hydroxy groups from biphenol optionally having a substituent on a benzene ring. Examples of the biphenol derivative having a substituent on a benzene ring include 2,2′-dimethylbiphenyl-4,4′-diol, 3,3′-dimethylbiphenyl-4,4′-diol, 3,3′,5,5′-tetramethylbiphenyl-4,4′-diol and 2,2′,3,3′,5,5′-hexamethylbiphenyl-4,4′-diol.

The group of formula (C) is one obtained by removing two hydroxy groups from 4,4′-isopropylidenediphenol (bisphenol A). The group of formula (D) is one obtained by removing two hydroxy groups from resorcinol.

In formula (E), p is an integer of 1 to 10. The group of formula (E) is one obtained by removing two hydroxy groups from a linear diol having 1 to 10 carbon atoms. Examples of the linear diol having 1 to 10 carbon atoms include ethylene glycol, and 1,4-butanediol.

The group of formula (F) is one obtained by removing two hydroxy groups from 1,4-cyclohexanedimethanol.

R³ in formula (G) is a hydrogen atom, a fluorine atom, or an alkyl group having 1 to 20 carbon atoms, and q is an integer of 0 to 4. The group of formula (G) is one obtained by removing two hydroxy groups from bisphenol fluorene optionally having a substituent on a benzene ring having a phenolic hydroxy group. Examples of the bisphenol fluorene derivative having a substituent on a benzene ring having a phenolic hydroxy group include biscresol fluorene. A case where X has a structure of formula (G) corresponds to both an acid dianhydride having a fluorene structure and a bis(trimellitic anhydride) ester. In such a case, the specific acid dianhydride is classified into the bis(trimellitic anhydride) ester. A compound in which X in formula (1) has a structure of formula (J) corresponds to any of the acid dianhydride having a fluorene structure, the acid dianhydride having a xanthene structure, and the bis(trimellitic anhydride) ester. In such a case, the specific acid dianhydride is classified into the bis(trimellitic anhydride) ester.

The bis(trimellitic anhydride) ester may be an aromatic ester. Among the above groups (A) to (K), groups (A), (B), (C), (D), (G), (H) and (I) are preferable as X. Among them, the groups (A) to (D) are preferable, and the group (B) having a biphenyl backbone is particularly preferable. When X is a group of general formula (B), X may be biphenylene or 2,2′,3,3′,5,5′-hexamethylbiphenyl-4,4′-diyl of the following formula (B1) from the viewpoint of the solubility of the polyamide-imide resin.

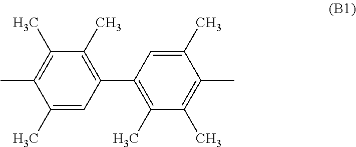

The acid dianhydride in which X is biphenylene in general formula (1) is bis(1,3-dioxo-1,3-dihydroisobenzofuran-5-carboxylic acid)-biphenyl-4,4′-diyl. The acid dianhydride in which X is a group of formula (B1) in general formula (1) is bis(1,3-dioxo-1,3-dihydroisobenzofuran-5-carboxylic acid)-2,2′,3,3′,5,5′-hexamethylbiphenyl-4,4′-diyl (TAHMBP), which is represented by the following formula (3).

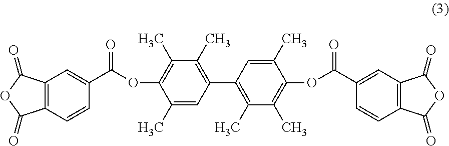

As the bis(trimellitic anhydride) ester in which X in general formula (1) has a structure other than formula (B), p-phenylenebis(trimellitic acid monoester acid anhydride) (TMHQ), bis(1,3-dioxo-1,3-dihydroisobenzofuran-5-carboxylic acid)-biphenyl-4,4′-diyl (OCBP-TME), 5,5′-(3,3′-dimethyl[1,1′-biphenyl]-4,4′-diyl)bis(1,3-dihydro-1,3-dioxo-5-isobenzofurancarboxylate) (BP-TME), tert-butylhydroquinone bis(trimellitate anhydride) (TA.BHQ), and trimethylhydroquinone bis(trimellitate anhydride) (TA.TMHQ) are preferable.

From the viewpoint of the solubility of the polyamide-imide, TMHQ, TAHMBP, and OCBP-TME are particularly preferable as the bis(trimellitic anhydride) ester.

Examples of the acid dianhydride having a fluorene structure include 9,9-bis(3,4-dicarboxyphenyl)fluorene dianhydride (BPAF), 9,9-bis[4-(3,4-dicarboxyphenoxy)phenyl]fluorene dianhydride (BPF-PA), N,N′-(9H-fluorene-9-ylidenedi-4,1-phenylene)bis[1,3-dihydro-1,3-dioxo-5-isobenzofurancarboxamide](FDA-ATA), and 5,5′-[9H-fluorene-9-ylidenebis(2-methyl-4,1-phenylene)]bis(1,3-dihydro-1,3-dioxo-5-isobenzofurancarboxylate) (TBIS·MPN). From the viewpoint of the solubility of the polyamide-imide, BPAF, BPF-PA, or TBIS·MPN is preferable, and in particular, BPAF or BPF-PA is particularly preferable.

Examples of the acid dianhydride having a xanthene structure include 5,5′-spiro[9H-fluorene-9,9′-[9H]xanthene]-3′,6′-diylbis(1,3-dihydro-1,3-dioxo-5-isobenzofurancarboxylate) (TBIS·RXN), and spiro[fluorene-9,9′-xanthene]-2′,3′,6′,7′-tetracarboxylic dianhydride (SFDA). Although these exemplary compounds include a xanthene structure and a fluorene structure, they are classified as acid dianhydrides having a xanthene structure in the classification of the specific acid dianhydride.

The polyamide-imide containing the above-described specific diamine as the diamine component and the specific acid dianhydride as the acid dianhydride component exhibits solubility in an organic solvent and tends to have high transparency and mechanical strength.

From the viewpoint of solubility in an organic solvent and transparency, among the specific acid dianhydrides, 4,4′-(4,4′-isopropylidenediphenoxy)diphthalic anhydride (BPADA), 3,4′-oxydiphthalic anhydride (a-ODPA), 4,4′-oxydiphthalic anhydride (s-ODPA), 9,9-bis(3,4-dicarboxyphenyl)fluorene dianhydride (BPAF), 9,9-bis[4-(3,4-dicarboxyphenoxy)phenyl]fluorene dianhydride (BPF-PA), 5,5′-[9H-fluorene-9-ylidenebis(2-methyl-4,1-phenylene)]bis(1,3-dihydro-1,3-dioxo-5-isobenzofurancarboxylate) (TBIS·MPN), spiro[fluorene-9,9′-xanthene]-2′,3′,6′,7′-tetracarboxylic dianhydride (SFDA), p-phenylene bis(trimellitic acid monoester acid anhydride) (TMHQ), bis(1,3-dioxo-1,3-dihydroisobenzofuran-5-carboxylic acid)-biphenyl-4,4′-diyl (OCBP-TME), and bis(1,3-dioxo-1,3-dihydroisobenzofuran-5-carboxylic acid)-2,2′,3,3′,5,5′-hexamethylbiphenyl-4,4′-diyl (TAHMBP) are preferable.

Among the specific acid dianhydrides, the acid dianhydride having an ether bond and the acid dianhydride having a fluorene structure and the acid dianhydride having a xanthene structure are preferable from the viewpoint of the UV resistance of the polyamide-imide. BPADA, a-ODPA, s-ODPA, BPAF, BPF-PA, and SFDA are particularly preferable from the viewpoint of solvent-solubility and mechanical strength. Since these acid dianhydrides do not have an ester bond and do not cause Fries rearrangement due to UV light, coloring hardly occurs when the polyamide-imide is exposed to the UV light. Also from the viewpoint of compatibility with the acryl-based resin described later, the specific acid dianhydride may be the acid dianhydride having an ether bond, the acid dianhydride having a fluorene structure, and the acid dianhydride having a xanthene structure.

From the viewpoint of making the polyamide-imide soluble in an organic solvent, the total amount of the specific acid dianhydride with respect to the total amount of the acid dianhydride component may be 15 mol % or more, 20 mol % or more, 25 mol % or more, 30 mol % or more, 35 mol % or more, 40 mol % or more, 45 mol % or more, or 50 mol % or more. The total amount of the specific acid dianhydride with respect to the total amount of the acid dianhydride component may be 100 mol %, or may be 95 mol % or less, 90 mol % or less, 85 mol % or less, 80 mol % or less, 75 mol % or less, or 70 mol % or less.

(Acid Dianhydride Other than Specific Acid Dianhydride)

The polyamide-imide may contain, as the acid dianhydride component, an acid dianhydride other than the specific acid dianhydride. Examples of such an acid dianhydride include an alicyclic tetracarboxylic dianhydride and an aromatic tetracarboxylic dianhydride. From the viewpoint of the environmental safety of the polyamide-imide, one that does not contain —C—CF₃ and —C—CF₂—C— is preferable, and one that does not contain a fluorine atom is particularly preferable.

The alicyclic tetracarboxylic dianhydride is only required to have at least one alicyclic structure, and may have both an alicyclic ring and an aromatic ring in one molecule. The alicyclic ring may be polycyclic, or may have a spiro structure. Examples of the alicyclic tetracarboxylic dianhydride include 1,2,3,4-cyclobutanetetracarboxylic dianhydride, 1,2,3,4-cyclopentanetetracarboxylic dianhydride, 1,3-dimethylcyclobutane-1,2,3,4-tetracarboxylic dianhydride, 1,2,3,4-tetramethyl-1,2,3,4-cyclobutanetetracarboxylic dianhydride, 1,2,4,5-cyclohexanetetracarboxylic dianhydride, 1,1′-bicyclohexane-3,3′,4,4′tetracarboxylic acid-3,4:3′,4′-dianhydride, norbornane-2-spiro-α-cyclopentanone-α′-spiro-2″-norbornane-5,5″,6,6″-tetracarboxylic dianhydride, 2,2′-binorbomane-5,5′,6,6′ tetracarboxylic dianhydride, 3-(carboxymethyl)-1,2,4-cyclopentanetricarboxylic-1,4:2,3-dianhydride, bicyclo[2.2.2]octa-7-ene-2,3,5,6-tetracarboxylic dianhydride, 4-(2,5-dioxotetrahydrofuran-3-yl)-1,2,3,4-tetrahydronaphthalene-1,2-dicarboxylic anhydride, cyclohexane-1,4-diylbis(methylene)bis(1,3-dioxo-1,3-dihydroisobenzofuran-5-carboxylate), 5-(2,5-dioxotetrahydrofuryl)-3-methyl-3-cyclohexene-1,2-dicarboxylic anhydride, 5,5′-[cyclohexylidenebis(4,1-phenyleneoxy)]bis-1,3-isobenzofurandione, 5-isobenzofurancarboxylic acid, 1,3-dihydro-1,3-dioxo-,5,5′-[1,4-cyclohexanediylbis(methylene)]ester, bicyclo[2.2.1]heptane-2,3,5,6-tetracarboxylic dianhydride, bicyclo[2.2.2]octane-2,3,5,6-tetracarboxylic dianhydride, 3,5,6-tricarboxynorbornane-2-acetic 2,3:5,6-dianhydride, decahydro-1,4,5,8-dimethanonaphthalene-2,3,6,7-tetracarboxylic dianhydride, tricyclo[6.4.0.0(2,7)]dodecane-1,8:2,7-tetracarboxylic dianhydride, octahydro-1H,3H,8H,10H-biphenyleno[4a,4b-c:8a,8b-c′]difuran-1,3,8,10-tetrone, ethylene glycolbis(hydrogenated trimellitic anhydride) ester, and decahydro[2]benzopyrano[6,5,4-def][2]benzopyran-1,3,6,8-tetrone. When the alicyclic tetracarboxylic dianhydride is contained in addition to the specific acid dianhydride as the acid dianhydride component, the mechanical strength of the polyamide-imide tends to be improved. When the polyamide-imide contains the alicyclic tetracarboxylic dianhydride as the acid dianhydride component, the compatibility between the polyamide-imide and the acryl-based resin tends to increase.

Among the alicyclic tetracarboxylic dianhydrides, from the viewpoint of the transparency and mechanical strength of the polyamide-imide, 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (H-PMDA), 4-(2,5-dioxotetrahydrofuran-3-yl)-1,2,3,4-tetrahydronaphthalene-1,2-dicarboxylic anhydride (TDA-100), bicyclo[2.2.2]octa-7-ene-2,3,5,6-tetracarboxylic dianhydride (BEDA), bicyclo[2.2.2]octane-2,3,5,6-tetracarboxylic dianhydride (BODA), and 1,1′-bicyclohexane-3,3′,4,4′-tetracarboxylic acid-3,4:3′,4′-dianhydride (H-BPDA) are preferable. In particular, from the viewpoint of mechanical strength, a tetracarboxylic anhydride in which two acid anhydride groups are bonded to one alicyclic ring is preferable, and CBDA is particularly preferable.

When the alicyclic tetracarboxylic dianhydride is used in addition to the specific acid dianhydride, the amount of the alicyclic tetracarboxylic dianhydride with respect to the total amount of the acid dianhydride component may be 1 mol % or more, 3 mol % or more, 5 mol % or more, 10 mol % or more, 12 mol % or more, or 15 mol % or more. The mechanical strength tends to increase as the amount of the alicyclic tetracarboxylic dianhydride increases. From the viewpoint of securing the solubility of the polyamide-imide in an organic solvent, the amount of the alicyclic tetracarboxylic dianhydride with respect to the total amount of the acid dianhydride component may be 80 mol % or less, 60 mol % or less, 50 mol % or less, 40 mol % or less, 30 mol % or less, or 20 mol % or less. The polyamide-imide containing the alicyclic tetracarboxylic dianhydride in the above range as the acid dianhydride component tends to be excellent in compatibility with the acryl-based resin.

Examples of the aromatic tetracarboxylic dianhydride other than the specific acid dianhydride include pyromellitic dianhydride (PMDA), 1,2,3,4-benzenetetracarboxylic dianhydride (MPDA), 3,3′,4,4′-benzophenonetetracarboxylic dianhydride, 2,2′,3,3′-benzophenonetetracarboxylic dianhydride, 2,2′,3,3′-biphenyltetracarboxylic dianhydride, 3,3′,4,4′-biphenyltetracarboxylic dianhydride (s-BPDA), 2,3,3′,4′-biphenyltetracarboxylic dianhydride (a-BPDA), 2,2′,3,3′-biphenyltetracarboxylic dianhydride (i-BPDA), 3,3′,4,4′-diphenylsulfonetetracarboxylic dianhydride (DSDA), 5,5′-dimethylmethylenebis (phthalic anhydride), 2,3,6,7-naphthalenetetracarboxylic dianhydride, 1,4,5,8-naphthalenetetracarboxylic dianhydride, 1,2,5,6-naphthalenetetracarboxylic dianhydride, terphenyltetracarboxylic dianhydride, 1,4-bis(3,4-dicarboxyphenoxy)benzene dianhydride, and bis(3,4-dicarboxyphenyl)sulfone dianhydride. Among these aromatic tetracarboxylic dianhydrides, a-BPDA, s-BPDA, i-BPDA, PMDA, MPDA, and DSDA are preferable from the viewpoint of improving mechanical strength.

When the aromatic tetracarboxylic dianhydride other than the specific acid dianhydride is used in addition to the specific acid dianhydride, the amount of the aromatic tetracarboxylic dianhydride other than the specific acid dianhydride with respect to the total amount of the acid dianhydride component may be 1 mol % or more, 3 mol % or more, 5 mol % or more, 10 mol % or more, 12 mol % or more, or 15 mol % or more. From the viewpoint of securing the solubility of the polyamide-imide in an organic solvent, the amount of the aromatic tetracarboxylic dianhydride other than the specific acid dianhydride with respect to the total amount of the acid dianhydride component may be 80 mol % or less, 60 mol % or less, 50 mol % or less, 40 mol % or less, 30 mol % or less, or 20 mol % or less.

The polyamide-imide may contain, as the acid dianhydride component, a chain aliphatic tetracarboxylic dianhydride such as ethylene tetracarboxylic dianhydride, 1,2,3,4-butanetetracarboxylic dianhydride, or meso-butane-1,2,3,4-tetracarboxylic dianhydride.

The amount of the fluorine atom-containing acid dianhydride with respect to the total amount of the acid dianhydride component of the polyamide-imide may be 30 mol % or less, 20 mol % or less, 10 mol % or less, 5 mol % or less, 1 mol % or less, or 0.5 mol % or less. The polyamide-imide may not contain the fluorine atom-containing acid dianhydride as the acid dianhydride component.

Among the fluorine atom-containing acid dianhydrides, those having a structure in which a trifluoromethyl group is bonded to a carbon atom (—C—CF₃) and/or a structure in which a carbon atom is bonded to each of both ends of a difluoromethylene group (—C—CF₂—C—) have low degradability and raise concerns regarding environmental safety. In particular, an acid dianhydride (for example, 4,4′-(hexafluoroisopropylidene)diphthalic anhydride, 9,9-bis(trifluoromethyl)xanthene tetracarboxylic dianhydride, 9-trifluoromethylxanthene tetracarboxylic dianhydride) having a structure in which CF₃— or —C(CF₃)₂— is directly bonded to a carbon atom of an aromatic ring has low degradability in the environment, and therefore, from the viewpoint of the environmental safety of the polyamide-imide, it is preferable that the polyamide-imide is substantially free of these acid dianhydrides. The amount of the acid dianhydride in which CF₃— or —C(CF₃)₂— is directly bonded to a carbon atom of an aromatic ring with respect to the total amount of the acid dianhydride component of the polyamide-imide may be less than 0.5 mol %, or 0.3 mol % or less, 0.1 mol % or less, or 0.05 mol % or less, or 0.

### (Polycarboxylic Acid)

As described above, by using the dicarboxylic acid and/or the tricarboxylic anhydride as the polycarboxylic acid component in addition to the diamine and the tetracarboxylic dianhydride, a polyamide-imide containing a structure derived from a dicarboxylic acid represented by general formula (VIa) and/or a structure derived from a tricarboxylic anhydride represented by general formula (VIIa) is obtained.

Examples of the dicarboxylic acid include: aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 2,6-naphthalenedicarboxylic acid, 4,4′-oxybisbenzoic acid, 4,4′-biphenyldicarboxylic acid, and 2-fluoroterephthalic acid; alicyclic dicarboxylic acids such as 1,4-cyclohexanedicarboxylic acid, 1,3-cyclohexanedicarboxylic acid, 1,2-hexahydroterephthalic acid, hexahydroisophthalic acid, 1,3-cyclopentanedicarboxylic acid, and bi(cyclohexyl)-4,4′-dicarboxylic acid; and heterocyclic dicarboxylic acids such as 2,5-thiophene dicarboxylic acid and 2,5-furandicarboxylic acid.

Examples of the tricarboxylic anhydride include trimellitic anhydride derivatives such as trimellitic anhydride, 2-fluorotrimellitic anhydride, 5-fluorotrimellitic anhydride, 6-fluorotrimellitic anhydride, 2,5-difluorotrimellitic anhydride, 2,6-difluorotrimellitic anhydride, 5,6-difluorotrimellitic anhydride, and 2,5,6-trifluorotrimellitic anhydride.

From the viewpoint of the solubility of the polyamide-imide, the polycarboxylic acid may be an aromatic dicarboxylic acid, an alicyclic dicarboxylic acid, and trimellitic anhydride, and may be an aromatic dicarboxylic acid. Among aromatic dicarboxylic acids, terephthalic acid, isophthalic acid, 4,4′-biphenyl dicarboxylic acid, and 4,4′-oxybisbenzoic acid are preferable, and of these, terephthalic acid and isophthalic acid are preferable, and terephthalic acid is particularly preferable. Among alicyclic dicarboxylic acids, 1,4-cyclohexanedicarboxylic acid and bi(cyclohexyl)-4,4′-dicarboxylic acid are preferred, and 1,4-cyclohexanedicarboxylic acid is particularly preferred.

In the preparation of the polyamide-imide and the polyamic acid as a precursor thereof, a polycarboxylic acid derivative such as a dicarboxylic acid dichloride, a dicarboxylic acid ester, a dicarboxylic anhydride, or a tricarboxylic acid anhydride chloride may be used instead of the polycarboxylic acid.

### <Ratio of Amide Structure in Polyamide-Imide>

In the polyamide-imide, the total of the tetracarboxylic-dianhydride-derived structure represented by general formula (IVa), the dicarboxylic-acid-derived structure represented by general formula (VIa), and the tricarboxylic-acid-derived structure represented by general formula (VIIa) may be 90 to 110 parts by mol, based on 100 parts by mol of the diamine-derived structure represented by general formula (Va). The total of the structure of general formula (IVa), the structure of general formula (VIa), and the structure of general formula (VIIa) may be 93 to 107 parts by mol, 95 to 105 parts by mol, 97 to 103 parts by mol, or 99 to 101 parts by mol, based on 100 parts by mol of the structure of general formula (Va).

The ratio of the total of the structure of general formula (VIa) and the structure of general formula (VIIa) to the total of the structure of general formula (IVa), the structure of general formula (VIa), and the structure of general formula (VIIa) is 1 to 99 mol %. The ratio between the structure of general formula (IVa) and the structure of general formula (VIa) is substantially equal to the ratio between the imide structure of general formula (I) and the amide structure of general formula (II), and the ratio between the structure of general formula (IVa) and the structure of general formula (VIIa) is substantially equal to the ratio between the imide structure of general formula (I) and the amideimide structure of general formula (III). The ratio of the total of the structure of general formula (VIa) and the structure of general formula (VIa) to the total of the structure of general formula (IVa), the structure of general formula (VIa), and the structure of general formula (VIIa) may be 5 mol % or more, 10 mol % or more, 20 mol % or more, 30 mol % or more, 40 mol % or more, or 50 mol % or more, and may be 80 mol % or less, 75 mol % or less or 70 mol % or less, 65 mol % or less, or 60 mol % or less.

As the ratio of the structures of general formulae (VIa) and (VIIa) increases, that is, as the ratio of the amide structure increases, the solubility of the polyamide-imide in the organic solvent may be improved.

The amount of the polycarboxylic acid with respect to the diamine component of the polyamide-imide used in one or more embodiments, that is, the total ratio of the structural units of general formula (VI) and general formula (VII) to the structural unit of general formula (V) may be 5 mol % or more, 10 mol % or more, 20 mol % or more, 30 mol % or more, 40 mol % or more, or 50 mol % or more, and may be 80 mol % or less, 75 mol % or less or 70 mol % or less, 65 mol % or less, or 60 mol % or less.

### <Content of Specific Fluorine Structure in Polyamide-Imide>

As described above, the polyamide-imide containing a diamine having one or more structures selected from CF₃—O—, —(CF₂—O)ₙ—, and —O—(CF₂—CF₂—O)ₙ— (specific diamine) as the diamine component exhibits solubility in an organic solvent without substantially containing a structure such as —C—CF₃ or —C—CF₂—C—.

In order to reduce the environmental persistence of the fluorine-containing compound, it is preferable the content of a monomer having a specific fluorine structure in the polyamide-imide is small. The specific fluorine structure is a structure having a trifluoromethyl group (CF₃—) or a difluoromethylene group (—CF₂—), wherein a structure that only contains a constituent element of the following structural formula (i) is excluded from the specific fluorine structure even having a trifluoromethyl group, and a structure that only contains a constituent element of the following structural formula (ii) is excluded from the specific fluorine structure even having a difluoromethylene group.

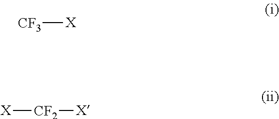

X in formulas (i) and (ii) is —OR or —NRR′, and X in formula (II) is any of —H, —CH₃, aromatic group, —C(O)—, —OR″, —SR″, and NR″R′″. R, R′, R″ and R′″ are each independently any of —H, —CH₃, —CH₂—, aromatic series, and —C(O)—.

From the viewpoint of improving the degradability in the environment, the amount of fluorine atoms contained in the specific fluorine structure per 1 kg of the polyamide-imide may be less than 500 mg, less than 300 mg, less than 100 mg, or less than 50 mg.

### <Preparation of Polyamide-Imide>

The method for preparing the polyamide-imide is not particularly limited. Generally, a polyamic acid as a polyamide-imide precursor is prepared by a reaction of a diamine with a tetracarboxylic dianhydride and a polycarboxylic acid or a derivative thereof, and the polyamide-imide is obtained by cyclodehydration (imidization) of the polyamic acid. As described above, the adjustment of the monomer composition constituting the polyamide-imide, i.e., the types and ratios of the acid dianhydride, the polycarboxylic acid or the derivative thereof, and the diamine, allows the polyamide-imide to have transparency and solubility in an organic solvent.

The method for preparing the polyamic acid is not particularly limited, and any known method can be applied. For example, a polyamic acid solution is obtained by dissolving and stirring the components in an organic solvent such that the total amount of the acid dianhydride and the polycarboxylic acid or the derivative thereof is substantially equimolar (molar ratio of 90:100 to 110:100) to the diamine. The concentration of the polyamic acid solution is usually 5 to 35 wt %, or may be 10 to 30 wt %. When the concentration is within this range, the polyamic acid obtained by polymerization has an appropriate molecular weight, and the polyamic acid solution has an appropriate viscosity.

In the polymerization of the polyamic acid, a method is preferable in which the acid dianhydride is added to the diamine for suppressing ring opening of the acid dianhydride. When a plurality of kinds of diamine and a plurality of kinds of acid dianhydride are added, they may be added atone time, or may be added in a plurality of additions. By adjusting the order of adding the monomers, various physical properties of the polyamide-imide can be controlled.

The organic solvent used for polymerization of the polyamic acid is not particularly limited as long as it does not react with the diamine or the acid dianhydride but can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethyl sulfone; amide-based solvents such as N,N-dimethylacetamide (DMAc), N,N-dimethylformamide (DMF), N,N′-diethylacetamide, N-methyl-2-pyrrolidone (NMP), γ-butyrolactone, and hexamethylphosphoric triamide; halogenated alkyl-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether, and p-cresol methyl ether. These solvents are typically used singly, or as necessary, two or more thereof are used in combination as appropriate. From the viewpoint of the solubility and polymerization reactivity of the polyamic acid, DMAc, DMF, NMP and the like may be used.

A polyamide-imide can be obtained by cyclodehydration of the polyamic acid. Examples of the method for preparing a polyamide-imide from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing a polyamide-imide generated by imidization of the polyamic acid, a polyamide-imide resin is precipitated as a solid. By isolating the polyamide-imide resin as a solid substance, impurities generated during synthesis of the polyamic acid, and the residual dehydrating agent and the imidization catalyst and the like can be washed and removed with the poor solvent, so that it is possible to prevent coloring of the polyamide-imide and an increase in yellowness index. By isolating the polyamide-imide resin as a solid, a solvent suitable for forming a film, such as a low-boiling-point solvent, can be applied in preparation of a solution for producing a film.

The molecular weight (weight average molecular weight in terms of polyethylene oxide which is measured by gel permeation chromatography (GPC)) of the polyamide-imide may be 10,000 to 1,000,000, 20,000 to 500,000, or 40,000 to 300,000. An excessively small molecular weight may result in insufficient strength of the film. An excessively large molecular weight may result in poor solubility of the polyamide-imide resin and compatibility with other resin.

The polyamide-imide may be soluble in an organic solvent. Specifically, the polyamide-imide may be dissolved at a concentration of 1 wt % or more in dimethylformamide (DMF) at 23° C. The polyamide-imide may be soluble in a non-amide-based solvent in addition to being soluble in an amide-based solvent such as DMF. Examples of the non-amide-based solvent include ketone-based solvents such as acetone and methyl ethyl ketone, halogenated alkyl-based solvents such as chloroform and dichloromethane, and ester-based solvents such as ethyl acetate and y-butyrolactone. The non-amide-based solvent has a boiling point lower than that of the amide-based solvent, and it is easy to remove the residual solvent at the time of preparing the film, so that the polyamide-imide soluble in the non-amide-based solvent can be expected to improve the productivity of the film. The polyamide-imide may be soluble in methylene chloride.

### [Resin Composition]

The polyamide-imide of one or more embodiments of the present invention can exhibit solubility in an organic solvent and also exhibit compatibility with other resin. The polyamide-imide of one or more embodiments of the present invention has particularly high compatibility with an acryl-based resin, and can be used as a resin composition containing the polyamide-imide and the acryl-based resin.

### <Acryl-Based Resin>

Examples of the acryl-based resin include poly(meth)acrylic acid esters such as polymethyl methacrylate, methyl methacrylate-(meth)acrylic acid copolymers, methyl methacrylate-(meth)acrylic acid ester copolymers, methyl methacrylate-acrylic acid ester-(meth)acrylic acid copolymers, and methyl(meth)acrylate-styrene copolymers. The tacticity of the polymer is not particularly limited, and may be any of an isotactic type, a syndiotactic type and an atactic type.

From the viewpoint of transparency, compatibility with the polyamide-imide, and mechanical strength of a molded article such as a film, it is preferable that the acryl-based resin has methyl methacrylate as a main structural unit. The amount of methyl methacrylate with respect to the amount of all monomer components in the acryl-based resin may be 60 wt % or more, 70 wt % or more, 80 wt % or more, 85 wt % or more, 90 wt % or more, or 95 wt % or more. The acryl-based resin may be a homopolymer of methyl methacrylate.

In the acryl-based resin, an imide structure or a lactone ring structure may be introduced. Such a modified polymer may be one obtained by introducing an imide structure or a lactone ring structure into an acrylic polymer having a methyl methacrylate content in the above-described range. In other words, in the acryl-based resin modified by introduction of an imide structure or a lactone ring structure, the total amount of methyl methacrylate and modified structures of methyl methacrylate may be 60 wt % or more, 70 wt % or more, 80 wt % or more, 85 wt % or more, 90 wt % or more, or 95 wt % or more. The modified polymer may be one obtained by introducing an imide structure or a lactone ring structure into a homopolymer of methyl methacrylate.

Introduction of an imide structure into an acrylic polymer such as methyl methacrylate tends to lead to improvement of the glass transition temperature of the acryl-based resin. Since the acryl-based resin includes an imide structure, compatibility with the polyamide-imide may be improved. For example, even when a specific polyamide-imide resin is not compatible with polymethyl methacrylate, the specific polyamide-imide resin can be compatible with an acryl-based resin having a glutarimide structure.

An acryl-based resin having a glutarimide structure is obtained by, for example, heating and melting a polymethyl methacrylate resin and performing treatment with an imidizing agent as described in Japanese Patent Laid-open Publication No. 2010-261025. As such imide-modified polymethyl methacrylate, a commercially-available product such as “PLEXIMID TT70” or “PLEXIMID 8805” manufactured by EVONIK may be used.

When the acryl-based resin has a glutarimide structure, the glutarimide content may be 3 wt % or more, 10 wt % or more, 20 wt % or more, 30 wt % or more, or 50 wt % or more. The glutarimide content is calculated by determining the ratio of introduction of the glutarimide structure (imidization ratio) from a ¹H-NMR spectrum of the acryl-based resin and converting the imidization ratio to a weight basis. For example, in methyl methacrylate into which a glutarimide structure has been introduced, the imidization ratio Im=B/(A+B) is determined, where A is an area of a peak originating from 0-CH₃ protons of methyl methacrylate (around 3.5 to 3.8 ppm) and B is an area of a peak originating from N—CH₃ protons of glutarimide (around 3.0 to 3.3 ppm).

From the viewpoint of the heat resistance of the resin composition and the molded article, the glass transition temperature of the acryl-based resin may be 100° C. or higher, 110° C. or higher, 115° C. or higher, or 120° C. or higher.

From the viewpoint of solubility in an organic solvent, compatibility with the polyamide-imide, and strength of the molded article, the weight average molecular weight (in terms of polystyrene) of the acryl-based resin may be 5,000 to 5,000,000, 10,000 to 2,000,000, 30,000 to 1,000,000, or 50,000 to 500,000. When the molecular weight of the acryl-based resin is too small, the durability of the resulting film may be deteriorated. When the molecular weight of the acryl-based resin is too high, the film formability may be poor.

From the viewpoint of the heat stability and light stability of the resin composition and the film, it is preferable that the content of reactive functional groups such as ethylenically unsaturated groups and carboxy groups in the acryl-based resin is small. The iodine value of the acryl-based resin may be 10.16 g/100 g (0.4 mmol/g) or less, 7.62 g/100 g (0.3 mmol/g) or less, or 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin may be 0.4 mmol/g or less, 0.3 mmol/g or less, or 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin, and improvement of compatibility with the polyamide-imide.

### <Preparation of Resin Composition Containing Polyamide-Imide and Acryl-Based Resin>

The polyamide-imide resin and the acryl-based resin are blended to prepare a resin composition. Since the polyamide-imide resin and the acryl-based resin at an arbitrary ratio can be compatible with each other, the ratio between the polyamide-imide resin and the acryl-based resin in the resin composition is not particularly limited. The blending ratio (weight ratio) of the polyamide-imide resin to the acryl-based resin may be 98:2 to 2:98, 95:5 to 10:90, or 90:10 to 15:85. When the ratio of the polyamide-imide resin is high, the elastic modulus of the film tends to increase, resulting in excellent mechanical strength. When the ratio of the acryl-based resin is high, coloring of the film tends to be suppressed, resulting in enhancement of transparency.

For sufficiently exhibiting the effect of improving transparency by blending the polyamide-imide and the acryl-based resin, the ratio of the amount of the acryl-based resin to the total amount of the polyamide-imide and the acryl-based resin may be 10 wt % or more, 15 wt % or more, 20 wt % or more, 25 wt % or more, 30 wt % or more, 35 wt % or more, 40 wt % or more, 45 wt % or more, or 50 wt % or more.

The polyamide-imide is a polymer having a special molecular structure, and generally has low solubility in an organic solvent and does not exhibit compatibility with other polymers. However, as described above, the polyamide-imide containing a specific diamine component and an acid dianhydride component exhibits high solubility in an organic solvent and also exhibits compatibility with an acryl-based resin.

A resin composition containing the polyamide-imide resin and the acryl-based resin may have a single glass transition temperature in differential scanning calorimetry (DSC) and/or dynamic viscoelasticity measurement (DMA). When the resin composition has a single glass transition temperature, it can be considered that the polyamide-imide resin and the acryl-based resin are completely compatible with each other. It is preferable that a film containing a polyamide-imide resin and an acryl-based resin also has a single glass transition temperature.

The resin composition may be one obtained by simply mixing a polyamide-imide resin and an acryl-based resin precipitated as a solid content, or may be one obtained by kneading a polyamide-imide and an acryl-based resin. When the polyamide-imide solution is mixed with a poor solvent to precipitate the polyamide-imide resin, an acryl-based resin may be mixed with the solution to precipitate a resin composition in which the polyamide-imide and the acryl-based resin are mixed as a solid (powder).

The resin composition may be a mixed solution containing a polyamide-imide resin and an acryl-based resin. The method for blending the resins is not particularly limited, and the resins may be mixed in a solid state, or may be mixed in a liquid to form a mixed solution. The polyamide-imide resin solution and the acryl-based resin solution may be individually prepared, and mixed to prepare a mixed solution of the polyamide-imide resin and the acryl-based resin.

The solvent of a solution containing the polyamide-imide resin and the acryl-based resin is not particularly limited as long as it exhibits an ability to dissolve both the polyamide-imide resin and the acryl-based resin. Examples of the solvent include amide-based solvents such as N,N-dimethylformamide, N,N-dimethylacetamide and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone, and methyl cyclohexanone; and halogenated alkyl-based solvents such as chloroform, 1,2-dichloroethane, 1,1,2,2-tetrachloroethane, chlorobenzene, dichlorobenzene, and methylene chloride.

From the viewpoint of the solubility of the polyamide-imide and the compatibility between the polyamide-imide and the acryl-based resin in the solution, amide-based solvents are preferable. Meanwhile, low-boiling-point non-amide-based solvents are preferable from the viewpoint of solvent removability in preparation of a molded article such as a film, and ketone-based solvents and halogenated alkyl-based solvents are preferable because they are excellent in ability to dissolve a polyamide-imide as well as an acryl-based resin, and have a low boiling point, so that it is easy to remove the residual solvent during preparation of a film.

In the resin composition, an organic or inorganic low molecular compound, a polymer compound (for example, an epoxy resin), or the like may be blended. The resin composition may contain a flame retardant, an ultraviolet absorber, a crosslinking agent, a dye, a pigment, a surfactant, a leveling agent, a plasticizer, fine particles, a sensitizer, and the like. The fine particles include organic fine particles such as those of polystyrene and polytetrafluoroethylene, and inorganic fine particles such as those of colloidal silica, carbon, and layered silicate, and may have a porous or hollow structure. Fiber reinforcement materials include carbon fibers, glass fibers, and aramid fibers.

A resin composition containing a polyamide-imide and an acryl-based resin tends to have a melt viscosity lower than that of a polyamide-imide alone, and is excellent in moldability in injection molding, transfer molding, press molding, melt extrusion molding and the like. A solution of a resin composition containing a polyamide-imide and an acryl-based resin tends to have a solution viscosity lower than that of a solution of a polyamide-imide alone, which has the same solid concentration. Therefore, the solution is excellent in handling properties such as transportability, and has a high coating property, which is advantageous in, for example, preventing film thickness unevenness.

Since a molded article obtained by molding a resin composition containing a polyamide-imide and an acryl-based resin from a solution has a lower glass transition temperature than that of a molded article obtained by molding from a solution of the same polyamide-imide alone, the amount of a residual solvent in the molded article tends to be low when the molded article is treated under the same heating condition. In particular, when an amide-based high-boiling-point solvent is used, heating at a high temperature of 250° C. or higher or 300° C. or higher may be required in order to remove the solvent, and as a result, the transparency of the resulting molded article may be deteriorated. In contrast, when a resin composition containing a polyamide-imide and an acryl-based resin is used, the amount of the remaining solvent can be reduced by heating in a shorter time, so that coloring during heating is suppressed, and a molded article having high transparency is easily obtained.

### [Molded Article and Film]

The polyamide-imide and the resin composition containing the polyamide-imide and the acryl-based resin can be used for forming various molded articles. Examples of a molding method include melting methods such as injection molding, transfer molding, press molding, blow molding, inflation molding, calender molding, and melt extrusion molding.

In one or more embodiments, the molded article is a film. The method for molding the film may be either a melting method or a solution method, and a solution method is preferable from the viewpoint of preparing a film excellent in transparency and uniformity. In the solution method, a solution containing the polyamide-imide is applied onto a support, and the solvent is removed by drying to obtain a film. Since the polyamide-imide and the acryl-based resin exhibit compatibility in a solution, a film having high transparency can be prepared by the solution method when the polyamide-imide and the acryl-based resin are used in combination.

As a method for applying the resin solution onto a support, a known method using a bar coater, a comma coater or the like can be applied. As the support, a glass substrate, a metal substrate, a metal drum, or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as the support. When a plastic film is used as the support, a material that is not soluble in a deposition solvent may be appropriately selected.

Heating may be performed when the solvent is dried. The heating temperature is not particularly limited as long as the solvent can be removed and coloring of the resulting film can be suppressed, and the temperature is appropriately set to room temperature to about 250° C., and may be 50° C. to 220° C. The heating temperature may be elevated stepwise. After drying proceeds to some extent, the resin film may be peeled off from the support and dried for enhancing the solvent removal efficiency. To promote the removal of the solvent, heating may be performed under reduced pressure.

For the purpose of, for example, improving the mechanical strength of the film, the film may be stretched in one direction or a plurality of directions. When the film is stretched, polymer chains are oriented in a stretching direction, and thus, the strength in an in-plane direction of the film is improved, and the occurrence of breaking and cracking of the film tends to be suppressed.

Since a cover film or a film used as a substrate material in a foldable display device (foldable display) is repeatedly bent along a bending axis at the same position, the film is required to have high mechanical strength in a direction perpendicular to the bending axis. Thus, by disposing the film such that the stretching direction of the film is perpendicular to the bending axis, the film is hardly broken or cracked at the bent portion even though bending is repeated, and a device having high bending resistance can be provided.

Stretching conditions of the film are not particularly limited. For example, the stretching temperature is about the glass transition temperature of the film ±40° C. The stretching temperature may be about 120 to 300° C., 150 to 250° C., or 180 to 230° C.

The stretch ratio is about 1 to 200%, and it may be 5 to 150%, 10 to 120%, or 20 to 100%. The stretch ratio (%) is represented by 100×(L₁−L₀)/L₀, where L₀ is the length (original length) of the film before stretching in the stretching direction, and L₁ is the length of the film after stretching in the stretching direction. The tensile modulus in the stretching direction tends to increase as the stretch ratio increases. In particular, in a compatible system of a polyamide-imide and an acryl-based resin, the tensile modulus in the stretching direction increases, and accordingly, the bending resistance tends to be improved. As the ratio of methyl methacrylate in the monomer component of the acryl-based resin is higher, the tensile modulus in the stretching direction tends to increase significantly. When the stretch ratio is excessively large, the mechanical strength in the direction perpendicular to the stretching direction tends to decrease, and the handleability of the film may decrease.

From the viewpoint of enhancing the strength in any in-plane direction, the film may be biaxially stretched. The biaxial stretching may be simultaneous biaxial stretching or sequential biaxial stretching. In the biaxial stretching, the stretch ratio in one direction and the stretch ratio in a direction perpendicular to the one direction may be the same or different. When a difference is provided in stretch ratio, the mechanical strength in a direction in which the stretch ratio is large tends to be relatively large. When a biaxially stretched film having anisotropy in stretch ratio is used for a foldable device, it is preferable to dispose the biaxially stretched film such that a direction in which the stretch ratio is large comes to a direction perpendicular to the bending axis.

The thickness of the film is not limited, and may appropriately be set according to the intended use of the film. The thickness of the film is, for example, 5 to 300 μm. From the viewpoint of achieving both self-supporting properties and flexibility and the viewpoint of obtaining a film having high transparency, the thickness of the film may be 20 μm to 200 μm, 30 μm to 150 μm, 40 μm to 100 μm, or 50 μm to 80 μm. The thickness of the film to be used as a cover film for displays may be 10 μm or more. When the film is stretched, the thickness after stretching may be within the above range.

Although it is not particularly limited, the haze of the film may be 10% or less, 5% or less, 4% or less, 3.5% or less, 3% or less, 2% or less, or 1% or less. The haze of the film may be as low as possible. As described above, since the polyamide-imide and the acryl-based resin exhibit compatibility, the film containing the polyamide-imide and the acryl-based resin has a low haze and excellent transparency as with the film of the polyamide-imide alone.

Although it is not particularly limited, the total light transmittance of the film may be 87% or more, 88% or more, 89% or more, or 90% or more. The film containing the polyamide-imide and the acryl-based resin has a higher total light transmittance than that of the film of the polyamide-imide alone, and can exhibit a total light transmittance of 90% or more.

Although it is not particularly limited, the yellowness index (YI) of the film may be 10 or less, 5.0 or less, 4.0 or less, 3.0 or less, 2.0 or less, 1.5 or less, or 1.0 or less. The film containing the polyamide-imide and the acryl-based resin has a lower YI than that of the film of the polyamide-imide alone. Even if the film of the polyamide-imide alone has a YI exceeding 10, the YI can be reduced by adopting a mixed system with the acryl-based resin. The film containing the polyamide-imide and the acryl-based resin can achieve a low YI of 1.0 or less.

From the viewpoint of strength, the tensile modulus of the film may be 2.5 GPa or more, 3.0 GPa or more, 3.5 GPa or more, or 4.0 GPa or more. The pencil hardness of the film may be 6B or more, 4B or more, B or more, H or more, 2H or more, or 3H or more. In the case of a system in which the polyamide-imide and the acrylic resin are compatible with each other, the pencil hardness tends to be less likely to decrease even when the ratio of the acrylic resin is increased. Therefore, it is possible to provide a film that is less colored and excellent in transparency without significantly reducing excellent mechanical strength characteristic of the polyamide-imide.

A film containing the polyamide-imide of one or more embodiments of the present invention is less colored and has high transparency, and is therefore suitably used as a display material. In particular, the film having high mechanical strength is applicable to surface members such as cover windows of displays. Since the polyamide-imide does not substantially contain a specific fluorine structure, the polyamide-imide has high degradability and excellent environmental safety. In practical use, a surface of the film of one or more embodiments of the present invention may be provided with an antistatic layer, an easily bondable layer, a hard coat layer, an antireflection layer, and the like.

### Examples

Hereinafter, one or more embodiments of the present invention will be described in further detail by showing Examples. One or more embodiments of the present invention are not limited to Examples below.

### [Preparation of Polyamide-Imide Resin]

N,N-dimethylacetamide (DMAc) was added into a separable flask and stirred in a nitrogen atmosphere. A diamine, a tetracarboxylic dianhydride and a polycarboxylic acid derivative were added thereto at the proportions (mol %) shown in Tables 1 and 2, and the mixture was stirred for 5 to 10 hours under a nitrogen atmosphere to react, whereby a polyamic acid solution having a solid content concentration of 10 wt % was obtained.

To 100 g of the polyamic acid solution, 5.5 g of pyridine as an imidization catalyst was added, and the mixture was completely dispersed. 8 g of acetic anhydride was then added, and the mixture was stirred at 90° C. for 3 hours to perform imidization. In Comparative Examples 1 to 4 in Table 2, the solubility of a polyamide-imide in DMAc was low and gelation or precipitation occurred during imidization, and thus the subsequent operations were not performed.

The solution after imidization was cooled to room temperature, and 100 g of 2-propyl alcohol (hereinafter, referred to as “IPA”) was then added dropwise at a rate of 2 to 3 drops/see while the solution was stirred, thereby precipitating a polyamide-imide. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours to obtain a polyamide-imide resin.

### [Preparation of Polyamide-Imide Film]

The polyamide-imide resin was dissolved in dimethylformamide (DMF) to prepare a polyamide-imide solution having a solid content concentration of 10 wt %. The polyamide-imide solution was applied onto an alkali-free glass plate, and dried by heating at 60° C. for 15 minutes, 90° C. for 15 minutes, 120° C. for 15 minutes, 150° C. for 15 minutes, 180° C. for 15 minutes, and 200° C. for 15 minutes in an air atmosphere to prepare films having a thickness of about 50 m.

### [Evaluation of Film]

### <Haze and Total Light Transmittance>

The film was cut to a 3 cm square, and the haze and the total light transmittance (TT) were measured in accordance with JIS K7136 and JIS K7361-1 using a haze meter “HZ-V3” manufactured by Suga Test Instruments Co., Ltd.

### <Total Light Transmittance>

The film was cut to a 3 cm square, and the total light transmittance (TT) was measured in accordance with JIS K7136 and JIS K7361-1 using a haze meter “HZ-V3” manufactured by Suga Test Instruments Co., Ltd.

### <Yellowness Index>

The film was cut to a 3 cm square, and the yellowness index (YI) was measured in accordance with JIS K7373 using a spectrophotometer “SC-P” manufactured by Suga Test Instruments Co., Ltd.

### <Tensile Modulus>

The film was cut into a strip shape having a width of 10 mm, and placed still at 23° C./55% RH for 1 day to perform humidity conditioning. The tensile modulus was then measured under the following conditions using “AUTOGRAPH AGS-X” manufactured by Shimadzu Corporation.

Distance between grippers: 100 mm

Tension rate: 20.0 mm/min

Measurement temperature: 23° C.

### [Evaluation Results]

The compositions of the polyamide-imides of Examples and Comparative Examples and the evaluation results of polyamide-imide films of Examples are shown in Tables 1 and 2. In Comparative Examples 1 to 4, a solvent-soluble polyamide-imide was not obtained, and thus only the compositions are shown in Table 2.

In Tables 1 and 2, and Table 3 described later, the composition of the polyamide-imide (the amount of the diamine, the tetracarboxylic dianhydride and the polycarboxylic acid derivative) is represented by a molar ratio in which a sum of the total amount of the tetracarboxylic dianhydride and the total amount of the polycarboxylic acid derivative is 100 parts by mol, and the compounds are described by the following abbreviations.

### <Diamine>

TFMOB: 2,2′-bis(trifluoromethoxy)benzidine
2,2-Bz: 2,2′-dimethylbenzidine
3,3′-DDS: 3,3′-diaminodiphenyl sulfone
BAFL: 9,9-bis(4-aminophenyl)fluorene
m-Tol: 4, 4′-diamino-2,2′-dimethylbiphenyl

### <Acid Dianhydride>

BPADA: 4,4′-(4,4′-isopropylidenediphenoxy)diphthalic anhydride
s-ODPA: 4,4′-oxydiphthalic anhydride
BPAF: 9,9-bis(3,4-dicarboxyphenyl)fluorene dianhydride
BPF-PA: 9,9-bis[4-(3,4-dicarboxyphenoxy)phenyl]fluorene dianhydride
TBIS·MPN: 5,5′-[9H-fluorene-9-ylidenebis(2-methyl-4,1-phenylene)]bis(1,3-dihydro-1,3-dioxo-5-isobenzofurancarboxylate)
TBIS·RXN: 5,5′-spiro[9H-fluorene-9,9′-[9H]xanthene]-3′,6′-diylbis(1,3-dihydro-1,3-dioxo-5-isobenzofurancarboxylate)
TAHMBP: bis(1,3-dioxo-1,3-dihydroisobenzofuran-5-carboxylic acid)-2,2′,3,3′,5,5′-hexamethylbiphenyl-4,4′-diyl
CBDA: 1,2,3,4-cyclobutanetetracarboxylic dianhydride
PMDA: pyromellitic dianhydride
BPDA: 3,3′,4,4′-biphenyltetracarboxylic dianhydride

### <Polycarboxylic Acid Derivative>

TPC: terephthaloyl dichloride
TMAC: trimellitic anhydride chloride

TABLE 1

| | Composition of polyamide-imide | | | | | | | | | |
|---|---|---|---|---|---|---|---|---|---|---|
| | Diamine | | | Acid dianhydride | | | | | | |
| | | 3,3′- | | | | BPF- | TBIS. | TBIS. | | |
| | TFMOB | DDS | BAFL | BPADA | BPAF | PA | MPN | RXN | TAHMBP | CBDA |
| Example 1 | 100 | — | — | 80 | — | — | — | — | — | — |
| Example 2 | 100 | — | — | 40 | — | — | — | — | — | — |
| Example 3 | 100 | — | — | 60 | — | — | — | — | — | 20 |
| Example 4 | 80 | 20 | — | 80 | — | — | — | — | — | — |
| Example 5 | 40 | 60 | — | 80 | — | — | — | — | — | — |
| Example 6 | 80 | — | 20 | 80 | — | — | — | — | — | — |
| Example 7 | 40 | — | 60 | 80 | — | — | — | — | — | — |
| Example 8 | 100 | — | — | 80 | — | — | — | — | — | — |
| Example 9 | 100 | — | — | — | 80 | — | — | — | — | — |
| Example 10 | 100 | — | — | — | 40 | — | — | — | — | — |
| Example 11 | 100 | — | — | — | 60 | — | — | — | — | 20 |
| Example 12 | 100 | — | — | — | 60 | — | — | — | — | — |
| Example 13 | 100 | — | — | — | 60 | — | — | — | — | — |
| Example 14 | 80 | 20 | — | — | 80 | — | — | — | — | — |
| Example 15 | 40 | 60 | — | — | 80 | — | — | — | — | — |
| Example 16 | 80 | — | 20 | — | 80 | — | — | — | — | — |
| Example 17 | 40 | — | 60 | — | 80 | — | — | — | — | — |
| Example 18 | 100 | — | — | — | 80 | — | — | — | — | — |
| Example 19 | 100 | — | — | — | — | 80 | — | — | — | — |
| Example 20 | 100 | — | — | — | — | — | 80 | | — | — |
| Example 21 | 100 | — | — | — | — | — | — | 80 | — | — |
| Example 22 | 95 | — | — | — | — | — | — | — | 50 | 30 |

| | | | | | Polyamide-imide film | | | | |
|---|---|---|---|---|---|---|---|---|---|
| | Composition of polyamide-imide | | | | | | | | Tensile |
| | Acid dianhydride | | Polycarboxylic acid | | Thickness | Haze | TT | | modulus |
| | PMDA | BPDA | TPC | TMAC | (μm) | (%) | (%) | YI | (GPa) |
| Example 1 | — | — | 20 | — | 49.7 | 0.4 | 88.9 | 2.5 | 3.4 |
| Example 2 | — | — | 60 | — | 50.5 | 0.7 | 88.9 | 3.3 | 3.9 |
| Example 3 | — | — | 20 | — | 48.9 | 0.4 | 89.2 | 2.8 | 3.9 |
| Example 4 | — | — | 20 | — | 50.6 | 0.2 | 88.7 | 2.6 | 3.3 |
| Example 5 | — | — | 20 | — | 49.7 | 0.4 | 88.4 | 2.7 | 3.3 |
| Example 6 | — | — | 20 | — | 51.3 | 0.5 | 88.4 | 3.4 | 3.3 |
| Example 7 | — | — | 20 | — | 45.7 | 0.8 | 88.2 | 3.2 | 3.2 |
| Example 8 | — | — | — | 20 | 47.3 | 0.5 | 89.2 | 3.8 | 3.2 |
| Example 9 | — | — | 20 | — | 50.1 | 0.3 | 88.7 | 2.3 | 4.6 |
| Example 10 | — | — | 60 | — | 49.6 | 0.4 | 88.7 | 2.6 | 5.0 |
| Example 11 | — | — | 20 | — | 49.4 | 0.3 | 89.1 | 2.2 | 4.9 |
| Example 12 | 20 | | 20 | — | 50.6 | 0.2 | 88.5 | 16.9 | 5.0 |
| Example 13 | — | 20 | 20 | — | 50.0 | 0.2 | 88.5 | 4.2 | 4.7 |
| Example 14 | — | — | 20 | — | 50.8 | 0.2 | 88.5 | 2.2 | 4.4 |
| Example 15 | — | — | 20 | — | 45.7 | 0.7 | 87.9 | 3.0 | 4.1 |
| Example 16 | — | — | 20 | — | 49.1 | 0.3 | 88.5 | 3.2 | 4.4 |
| Example 17 | — | — | 20 | — | 51.1 | 0.3 | 87.9 | 4.0 | 4.1 |
| Example 18 | — | — | — | 20 | 49.3 | 0.2 | 88.9 | 4.2 | 4.4 |
| Example 19 | — | — | 20 | — | 49.4 | 0.3 | 87.9 | 4.2 | 3.7 |
| Example 20 | — | — | 20 | — | 47.3 | 0.3 | 88.8 | 5.7 | 4.2 |
| Example 21 | — | — | 20 | — | 49.8 | 0.3 | 88.5 | 7.3 | 4.0 |
| Example 22 | — | — | 20 | — | 41.1 | 3.2 | 87.5 | 13.2 | 5.9 |

TABLE 2

| | Composition of polyamide-imide | | | | | | | |
|---|---|---|---|---|---|---|---|---|
| | | | | | | | | Polycarboxylic |
| | Diamine | Acid dianhydride | | | | | | acid |
| | m-Tol | s-ODPA | BPADA | TAHMBP | CBDA | PMDA | BPDA | TPC |
| Comparative | 100 | — | — | 50 | — | — | — | 50 |
| Example 1 | | | | | | | | |
| Comparative | 100 | 50 | — | — | — | — | — | 50 |
| Example 2 | | | | | | | | |
| Comparative | 100 | — | 40 | — | 30 | — | — | 30 |
| Example 3 | | | | | | | | |
| Comparative | 100 | — | 40 | — | — | 30 | — | 30 |
| Example 4 | | | | | | | | |

Polyamide-imides of Examples 1 to 22 containing a specific diamine as a diamine component were soluble in an organic solvent, and transparent films could be prepared. Meanwhile, in Comparative Examples 1 to 4 containing no specific diamine, the polyamide-imide was insoluble in an organic solvent.

These results show that by using a specific diamine not containing a specific fluorine structure as the diamine component, polyamide-imides having high environmental safety and excellent solubility in an organic solvent and transparency can be obtained.

### [Preparation of Resin Composition Containing Polyamide-Imide and Acrylic Resin]

The polyamide-imide of Example 1 and a glutarimide-modified acrylic resin (prepared according to “Acrylic Resin Production Example 3” in JP 2018-70710 A; glutarimide content: 33 wt %, glass transition temperature: 131° C., hereinafter referred to as “HGI”) were dissolved in DMF at a weight ratio of 50:50 to prepare a solution having a solid content concentration of 10 wt %. The polyamide-imide of each of Examples 3, 9 to 14, 16, 18, 21, and 22 and a commercially available polymethyl methacrylate resin (“PARAPET HM 1000” manufactured by Kuraray Co., Ltd., glass transition temperature: 120° C., acid value: 0.0 mmol/g, hereinafter referred to as “IHM”) were dissolved in DMF at a weight ratio of 50:50 to prepare a solution having a solid content concentration of 10 wt %. In all the examples, the mixed resin solution was transparent, and the polyamide-imide and the acrylic resin showed compatibility.

### [Preparation and Evaluation of Films]

The mixed resin solution was applied onto an alkali-free glass plate, and dried by heating at 60° C. for 15 minutes, 90° C. for 15 minutes, 120° C. for 15 minutes, 150° C. for 15 minutes, 180° C. for 15 minutes, and 200° C. for 15 minutes in an air atmosphere to prepare films having a thickness of about 50 μm.

The obtained films were evaluated in the same manner as the polyamide-imide films. The compositions of the polyamide-imides, kinds of acryl-based resins, and the evaluation results of the films are shown in Table 3.

TABLE 3

| | Composition of polyamide-imide | | | | | | | | | |
|---|---|---|---|---|---|---|---|---|---|---|
| | Diamine | | | Acid dianhydride | | | | | | |
| | | 3,3′- | | | | TBIS. | | | | |
| | TFMOB | DDS | BAFL | BPADA | BPAF | RXN | TAHMBP | CBDA | PMDA | BPDA |
| Example 101 | 100 | — | — | 80 | — | — | — | — | — | — |
| Example 103 | 100 | — | — | 60 | — | — | — | 20 | — | — |
| Example 109 | 100 | — | — | — | 80 | — | — | — | — | — |
| Example 110 | 100 | — | — | — | 40 | — | — | — | — | — |
| Example 111 | 100 | — | — | — | 60 | — | — | 20 | — | — |
| Example 112 | 100 | — | — | — | 60 | — | — | — | 20 | |
| Example 113 | 100 | — | — | — | 60 | — | — | — | — | 20 |
| Example 114 | 80 | 20 | — | — | 80 | — | — | — | — | — |
| Example 116 | 80 | — | 20 | — | 80 | — | — | — | — | — |
| Example 118 | 100 | — | — | — | 80 | — | — | — | — | — |
| Example 121 | 100 | — | — | — | — | 80 | — | — | — | — |
| Example 122 | 95 | — | — | — | — | — | 50 | 30 | — | — |

| | Composition of | | | | | | | |
|---|---|---|---|---|---|---|---|---|
| | polyamide-imide | | Polyamide-imide/acrylic mixed resin film | | | | | |
| | Polycarboxylic | | | | | | | Tensile |
| | acid | | Acrylic | Thickness | Haze | TT | | modulus |
| | TPC | TMAC | type | (μm) | (%) | (%) | YI | (GPa) |
| Example 101 | 20 | — | HGI | 51.6 | 0.4 | 90.9 | 1.2 | 3.6 |
| Example 103 | 20 | — | HM | 49.5 | 0.4 | 90.9 | 1.2 | 3.6 |
| Example 109 | 20 | — | HM | 51.4 | 0.4 | 90.8 | 0.9 | 4.2 |
| Example 110 | 60 | — | HM | 54.2 | 0.4 | 90.9 | 1.2 | 4.4 |
| Example 111 | 20 | — | HM | 50.0 | 0.4 | 91.0 | 1.0 | 4.5 |
| Example 112 | 20 | — | HM | 50.9 | 0.3 | 90.8 | 4.2 | 4.5 |
| Example 113 | 20 | — | HM | 52.9 | 0.3 | 90.7 | 1.6 | 4.2 |
| Example 114 | 20 | — | HM | 54.0 | 0.4 | 90.7 | 1.0 | 4.1 |
| Example 116 | 20 | — | HM | 50.2 | 0.3 | 90.7 | 1.2 | 4.1 |
| Example 118 | — | 20 | HM | 49.8 | 0.3 | 90.8 | 1.4 | 3.9 |
| Example 121 | 20 | — | HM | 49.0 | 0.4 | 90.8 | 2.4 | 3.8 |
| Example 122 | 20 | — | HM | 42.8 | 1.5 | 90.6 | 4.4 | 4.4 |

The films of Examples 101, 103, 109 to 114, 116, 118, 121 and 122, which were mixed resin films of the polyamide-imide and the acryl-based resin, had equivalent mechanical strength (tensile modulus) as that of the films of Examples 1, 3, 9 to 14, 16, 18, 21 and 22, which were films of the polyamide-imide alone, and tended to have transparency improved as compared with the films of the polyamide-imide alone. For example, the polyamide-imide film of Example 12 had a YI of more than 10, whereas the film of Example 112 had a YI of 4.2 and a total light transmittance of more than 9000, indicating that transparency was remarkably improved. Also in other examples, it can be seen that the mixed resin film of the polyamide-imide and the acrylic resin has lower YI, higher total light transmittance, and more excellent transparency than those of a film of the polyamide-imide alone.

These results show that a polyamide-imide containing a specific diamine used as a diamine component exhibits solubility in an organic solvent and excellent compatibility with an acryl-based resin, and a film having high transparency can be obtained.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A polyamide-imide comprising:
a diamine component;
a tetracarboxylic dianhydride component; and
a polycarboxylic acid component,
wherein the diamine component comprises a fluorine atom-containing diamine having one or more structures selected from CF₃—O—, —(CF₂—O)ₙ—, and —O—(CF₂—CF₂—O)ₙ—, where n is an integer of 1 to 20.

2. The polyamide-imide according to claim 1, wherein the fluorine atom-containing diamine is 2,2′-bis(trifluoromethoxy)benzidine, 3,3′-bis(trifluoromethoxy)benzidine, or 2,3′-bis(trifluoromethoxy)benzidine.

3. The polyamide-imide according to claim 1, wherein the tetracarboxylic dianhydride component comprises one or more tetracarboxylic dianhydrides selected from the group consisting of a tetracarboxylic dianhydride having an ether bond, a tetracarboxylic dianhydride having a fluorene structure, a tetracarboxylic dianhydride having a xanthene structure, and a bis(trimellitic anhydride) ester.

4. The polyamide-imide according to claim 3, wherein the one or more tetracarboxylic dianhydrides are one or more selected from the group consisting of 4,4′-(4,4′-isopropylidenediphenoxy)diphthalic anhydride, 3,4′-oxydiphthalic anhydride, 4,4′-oxydiphthalic anhydride, 9,9-bis(3,4-dicarboxyphenyl)fluorene dianhydride, 9,9-bis[4-(3,4-dicarboxyphenoxy)phenyl]fluorene dianhydride, 5,5′-[9H-fluorene-9-ylidenebis(2-methyl-4,1-phenylene)]bis(1,3-dihydro-1,3-dioxo-5-isobenzofurancarboxylate), spiro[fluorene-9,9′-xanthene]-2′,3′,6′,7′-tetracarboxylic dianhydride, 5,5′-spiro[9H-fluorene-9,9′-[9H]xanthene]-3′,6′-diylbis(1,3-dihydro-1,3-dioxo-5-isobenzofurancarboxylate), p-phenylene bis(trimellitic acid monoester acid anhydride), bis(1,3-dioxo-1,3-dihydroisobenzofuran-5-carboxylic acid)-biphenyl-4,4′-diyl, and bis(1,3-dioxo-1,3-dihydroisobenzofuran-5-carboxylic acid)-2,2′,3,3′,5,5′-hexamethylbiphenyl-4,4′-diyl.

5. The polyamide-imide according to claim 3, wherein the tetracarboxylic dianhydride component further comprises one or more selected from the group consisting of 2,3,3′,4′-biphenyltetracarboxylic dianhydride, 3,3′,4,4′-biphenyltetracarboxylic dianhydride, 2,2′,3,3′-biphenyltetracarboxylic dianhydride, pyromellitic dianhydride, 1,2,3,4-benzenetetracarboxylic dianhydride, and 3,3′,4,4′-diphenylsulfonetracarboxylic dianhydride.

6. The polyamide-imide according to claim 1, comprising an alicyclic tetracarboxylic dianhydride as the tetracarboxylic dianhydride component, wherein an amount of the alicyclic tetracarboxylic dianhydride with respect to a total amount of the tetracarboxylic dianhydride component is 1 to 80 mol %.

7. The polyamide-imide according to claim 6, wherein the alicyclic tetracarboxylic dianhydride is one or more selected from the group consisting of 1,2,3,4-cyclobutanetetracarboxylic dianhydride, 1,2,3,4-cyclopentanetetracarboxylic dianhydride, 1,2,4,5-cyclohexanetetracarboxylic dianhydride, 4-(2,5-dioxotetrahydrofuran-3-yl)-1,2,3,4-tetrahydronaphthalene-1,2-dicarboxylic anhydride, bicyclo[2.2.2]octa-7-ene-2,3,5,6-tetracarboxylic dianhydride, bicyclo[2.2.2]octane-2,3,5,6-tetracarboxylic dianhydride, and 1,1′-bicyclohexane-3,3′,4,4′-tetracarboxylic acid-3,4:3′,4′-dianhydride.

8. The polyamide-imide according to claim 1, wherein
an amount of a diamine having a structure in which CF₃— or —C(CF₃)₂— is directly bonded to a carbon atom of an aromatic ring is less than 0.5 mol % with respect to a total amount of the diamine component, and
an amount of a tetracarboxylic dianhydride having a structure in which CF₃— or —C(CF₃)₂— is directly bonded to a carbon atom of an aromatic ring is less than 0.5 mol % with respect to a total amount of the tetracarboxylic dianhydride component.

9. The polyamide-imide according to claim 1, wherein the polyamide-imide is soluble in dimethylformamide at 23° C.

10. A molded article comprising the polyamide-imide according to claim 1.

11. A film comprising the polyamide-imide according to claim 1.

12. A resin composition comprising:
the polyamide-imide according to claim 1; and
an acryl-based resin.

13. The resin composition according to claim 12, wherein a weight ratio of the polyamide-imide to the acryl-based resin is in a range of 98:2 to 2:98.

14. A molded article comprising the resin composition according to claim 12.

15. A film comprising the resin composition according to claim 12.
